(19) United States
(12) Patent Application Publication
(10) Pub. No.: US 2026/0111983 A1
(43) Pub. Date: Apr. 23, 2026

(54) System

(71) Applicant: Softbank Group Corp., Tokyo (JP)

(72) Inventor: Kaori Sato, Tokyo (JP)

(21) Appl. No.: 19/361,636

(22) Filed: Oct. 17, 2025

(30) Foreign Application Priority Data
Oct. 21, 2024 (JP) 2024-185549

(51) Int. Cl. G06Q 50/26; H04W 4/90

(52) U.S. Cl. CPC G06Q 50/265; H04W 4/90

(57) ABSTRACT

A system includes a processor that collects audio data, image data, and text data from a device, performs multimodal analysis on the data collected from the device, diagnoses applicable support programs based on analysis results obtained by the multimodal analysis, notifies a user of a diagnosis result, and shares the diagnosis result with a local government.

### CROSS-REFERENCE TO RELATED APPLICATION

This application is based on and claims priority under 35 USC 119 from Japanese Patent Application No. 2024-185549 filed on October 21, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In the event of a disaster, victims often encounter difficulties in promptly providing accurate reports of their situation and in determining which support programs are applicable to their circumstances. Existing systems are typically unable to seamlessly collect multimodal data such as audio, images, and text, analyze such information efficiently, and match it to the most appropriate support programs. Consequently, there is a delay in delivering suitable assistance, and both disaster victims and local authorities face unnecessary burdens during the support application and review process.

### SUMMARY

The present invention provides a system including a processor that collects audio, image, and text data from a device, performs multimodal analysis on the collected data, diagnoses applicable support programs based on the analysis results, notifies the user of the diagnosis result, and shares the result with a local government. By integrating advanced natural language processing and image processing algorithms, the system enables accurate and efficient assessment of disaster situations and streamlines communication among victims, support providers, and authorities, thereby realizing prompt and appropriate allocation of support resources.

“Processor” means a central processing unit or computational element capable of executing programmed instructions to perform specified operations within the system.

“Device” means an electronic apparatus, such as a smartphone, tablet, or personal computer, which is capable of collecting and providing data including audio, image, and text information.

“Audio data” means information or signals representing sound, including but not limited to human speech, which is collected and processed by the system.

“Image data” means digital representations of visual information, including photographs or videos, which capture scenes or objects and are utilized by the system.

“Text data” means character-based information, such as written descriptions, annotations, or other alphanumeric content that is processed by the system.

“Multimodal analysis” means the processing and interpretation of multiple types of data, such as audio, image, and text, in an integrated manner to extract meaningful information.

“Analysis results” means the output or findings obtained from the multimodal analysis of the collected data.

“Support programs” means organized assistance schemes or aid systems provided by governmental or other entities to individuals affected by a disaster.

“Diagnosis” means the determination of which support programs are applicable to the user, based on the analysis results.

“Notification” means the act of informing or alerting the user, especially regarding the diagnosis results or subsequent actions to be taken.

“Local government” means the administrative body or municipality responsible for providing public services and support within a defined geographic area.

“Natural language processing algorithm” means a computational method for analyzing and interpreting human language in textual or spoken form.

“Image processing algorithm” means a computational technique for analyzing, interpreting, or modifying digital images.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

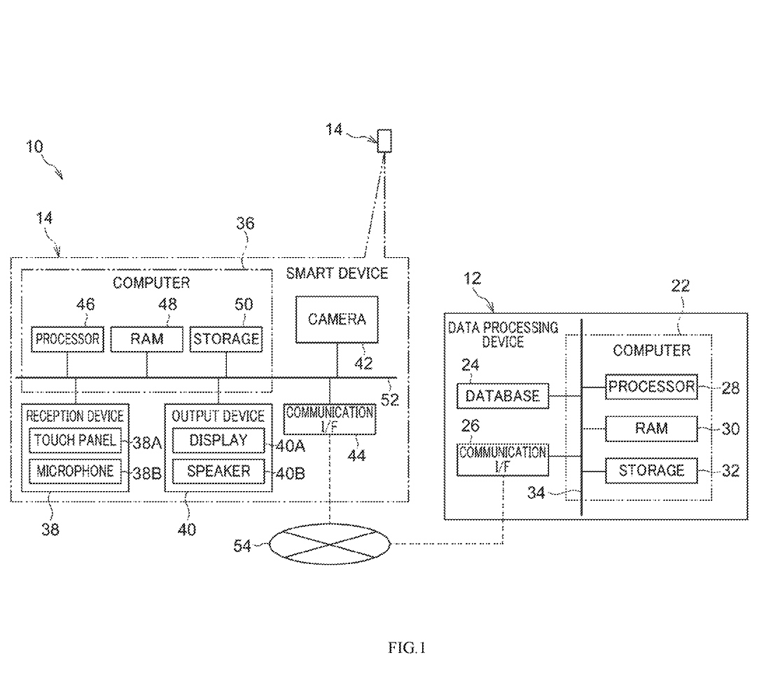

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

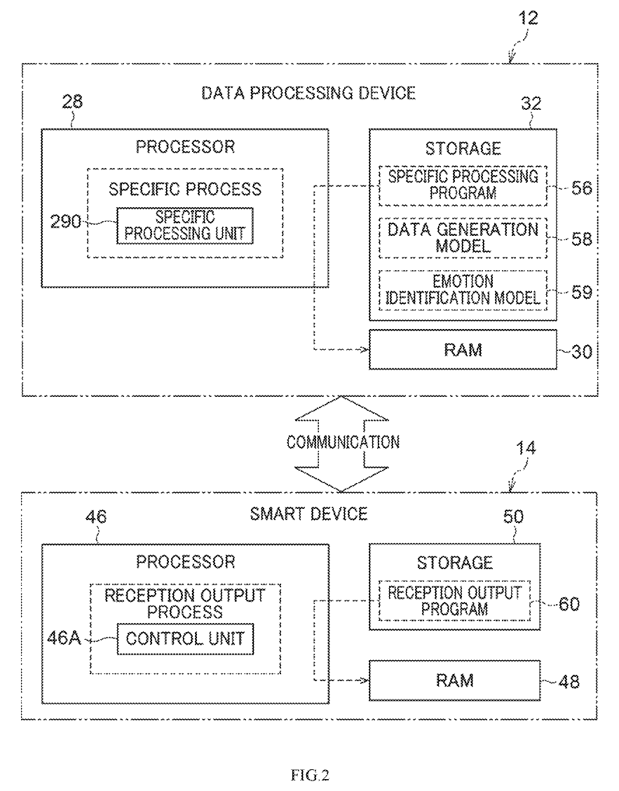

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In the event of a disaster, victims and relevant institutions are often unable to promptly and efficiently identify and access appropriate support measures due to the complexity and slowness of information collection, analysis, and matching procedures. Traditional systems are limited in their ability to collect and process various types of information such as audio, visual, and textual data in an integrated manner, leading to delays in the delivery of suitable support and inefficient communication with public institutions.

The specific processing by the specific processing unit 290 of the data processing device 12 in Example 1 is realized by the following means.

The present invention provides a server comprising a processor configured to obtain spatial, acoustic, visual, and symbolic information via an information collection device, convert and integrate the information for multimodal analysis, generate an analysis instruction in a predetermined format for a generative artificial intelligence model, execute comprehensive analysis by inputting the instruction and information to the model, determine applicable support measures based on the analysis results, notify users of the relevant support information, and communicate the outcome with public institutions. This enables rapid and efficient identification and delivery of appropriate support to disaster victims, and streamlines the sharing of situational data with administrative bodies.

The term “spatial information” refers to data related to physical location, position, or geographical attributes gathered from collection devices, such as GPS data, coordinates, or mapping information.

The term “acoustic information” refers to digital representations of sound data, including but not limited to recorded voice messages, environmental sounds, or any other auditory signals captured through microphones or similar sensors.

The term “visual information” refers to digital data representing images or video footage, encompassing still images, video frames, or any visual recordings acquired by optical sensors or cameras.

The term “symbolic information” refers to data expressed in the form of written characters, numerals, codes, or any other textual elements provided by user input, file upload, or conversions from audio or visual sources.

The term “information collection device” refers to an apparatus such as a portable information processing terminal, mobile device, or computer equipped with components (e.g., camera, microphone, GPS) that enable the acquisition of various types of data including spatial, acoustic, visual, and symbolic information.

The term “data transmission means” refers to any technology or module for electronically transferring data between devices, such as wireless communication protocols, network interfaces, or software for secure data upload and download.

The term “multimodal analysis data structure” refers to an integrated format or schema into which various types of input data are organized and prepared for analysis by artificial intelligence models, ensuring compatibility and comprehensive data representation.

The term “analysis instruction sentence” refers to a formatted textual prompt or set of commands generated for directing a generative artificial intelligence model to perform specific analytical tasks based on the integrated data.

The term “generative artificial intelligence model” refers to a machine learning system capable of receiving diverse data inputs and autonomously producing analytic results, inferences, or recommendations by processing information through natural language processing, image analysis, or multimodal learning techniques.

The term “support measure information” refers to a collection of data describing available administrative support programs, aid policies, or relief schemes that may be applicable to users’ situations as identified by the analysis.

The term “user terminal” refers to a client device used by the end user, such as a mobile terminal, computer, or tablet, which receives notifications or results from the server.

The term “external information system” refers to an information management platform, such as municipal, governmental, or institutional computer systems, that is external to the disclosed system and serves as a recipient or sharer of support-related or analytical information.

The term “public institution” refers to an administrative, governmental, or municipal body responsible for delivering, managing, or coordinating public aid, services, or support programs for users.

One embodiment for implementing the present invention is described as follows. The system consists of a server, at least one terminal serving as an information collection device, and communication infrastructure that enables data exchange between them and with external information systems.

The user utilizes a terminal, such as a portable information processing apparatus (for example, a smartphone, tablet, or personal computer), which is equipped with hardware components including a camera for acquiring visual information, a microphone for capturing acoustic information, and a location module (such as GPS) for collecting spatial information. The terminal also includes software that allows the user to input symbolic information through either voice-to-text conversion or manual text input.

The terminal combines visual, acoustic, spatial, and symbolic information into a data package, appends temporal and location metadata, and transmits the data securely to the server using network protocols such as HTTPS or another secure data transmission means. The terminal may use standard software frameworks such as Android, iOS, or other operating systems for data acquisition and transmission.

The server, implemented on a computing platform such as a cloud-based or on-premise server, receives the multi-source data and stores it within a secure storage area (for example, a local storage directory or a network-based object storage service). The server then consolidates and formats the incoming visual, acoustic, spatial, and symbolic information into a multimodal analysis data structure suitable for artificial intelligence processing. For instance, the server may use an open-source library for image analysis, such as OpenCV, and for speech-to-text conversion, the server may utilize APIs available through mainstream providers offering speech recognition services.

After organizing the information, the server generates an analysis instruction sentence (prompt sentence) in a predetermined format. This sentence encapsulates the situation based on the provided data and is designed to leverage the reasoning capability of a generative artificial intelligence model. For example, a prompt sentence may be:

"Given the following: (1) Images showing severe damage to the home structure, (2) Transcribed message: 'The building has collapsed and immediate help is required,' and (3) Location information: [coordinates], please determine the most appropriate emergency support program and describe the eligibility for the applicant."

The server inputs both this prompt sentence and the coded multimodal data into a generative AI model that is capable of multimodal analysis, such as a large language model supporting both natural language processing technology and image information processing. The server may employ commercially available models that allow API-based access or operate models on dedicated hardware. The generative AI model processes the full range of information and returns analytical results that infer the user's situation and propose applicable support measures.

Based on the output from the generative AI model, the server accesses a support measure information database, implemented as a structured data set on a storage system (such as SQL-based database software), to identify and extract relevant support programs and administrative resources appropriate to the user’s case.

The server then notifies the user terminal of the recommended support measures via a push notification or equivalent information transfer mechanism to allow prompt access to the results. At the same time, the server communicates the same results to an external information system managed by a public institution, such as a local government agency, using a secure network interface and standardized data exchange protocol.

For example, after an earthquake, a user may use a smartphone to record video footage of a collapsed building, add a voice recording stating "The building is unsafe, we need immediate assistance," and input "Immediate shelter required" via text. The terminal transmits all collected data to the server. The server then generates a prompt such as:

"Analyze this image and transcribed message: 'The building is unsafe, we need immediate assistance.' Determine the most urgent disaster relief and specify any government aid programs that match."

Upon processing, the server receives a determination from the generative AI model that emergency shelter assistance is needed and sends this result to both the user and the local emergency management office.

This embodiment enables rapid, accurate, and integrated assessment of disaster situations by combining heterogeneous information streams, fully leveraging generative AI capabilities to enhance both individual support and administrative decision-making.

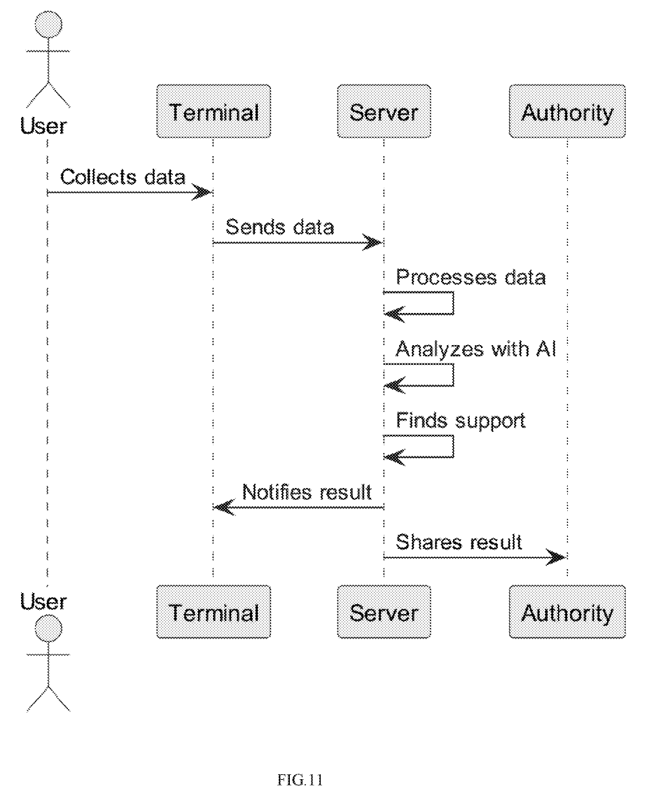

The following describes the processing flow using FIG. 11.

### Step 1:

The user operates the terminal at the disaster site to collect information. As input, the user uses the terminal’s camera to capture images or videos of the damaged area, the microphone to record voice descriptions of the situation, and the device’s interface to type additional comments or select relevant options. The terminal processes this input by creating digital files for each media type and adds location and time metadata. As output, the terminal generates a data package containing visual, acoustic, symbolic, spatial, and temporal information.

### Step 2:

The terminal performs preprocessing and packaging of the acquired data. The terminal aggregates the image/video files, audio recording, text input, GPS coordinates, and timestamps into a structured data object. The terminal checks file integrity and ensures each required data field is included. As input, the system receives raw user-generated content; as output, it produces a validated, structured data bundle ready for transmission.

### Step 3:

The terminal securely transmits the structured data package to the server. As input, the terminal uses the prepared data bundle. The terminal establishes a secure HTTPS connection or equivalent secure protocol, and uploads the package via an API endpoint. As output, the server receives the full dataset, and the terminal displays a notification confirming successful upload.

### Step 4:

The server receives and stores the uploaded data. The server, as input, accepts digital files and structured metadata from the terminal. The server writes these files to secure local or cloud-based storage, and logs incoming data, ensuring completeness and authenticity. As output, the server has persistent copies of the user’s submissions.

### Step 5:

The server converts raw data into a format suitable for multimodal analysis. The server, as input, uses stored image, audio, text, and metadata. The server applies automated processes, such as speech-to-text transcription for audio (using a speech recognition module), frame extraction for video (using image processing software), and text normalization for symbolic input. The server combines these into a unified JSON or equivalent object. The output is a multimodal data structure.

### Step 6:

The server generates a prompt sentence and prepares the AI input. The server, as input, uses the multimodal data object. The server crafts a descriptive prompt sentence summarizing the incident and inserts the user’s actual data - for example: “Given these image and text inputs, determine the most suitable government support.” The output is a package containing the formatted prompt and accompanying multimodal data.

### Step 7:

The server executes multimodal analysis with the generative AI model. As input, the server passes the prompt and structured data to the AI model. The server invokes the model API, which processes the image(s), transcribed audio, and textual content, extracting features, identifying needs, and reasoning about support options. As output, the server receives an analytical result that identifies the user situation and recommended support measures.

### Step 8:

The server identifies the applicable support measure. The server, as input, takes the AI’s output with its needs analysis and keywords. The server queries a support measure database, filtering for programs matching the case’s parameters (e.g., eligibility requirements, urgency). The output is a tailored set of support measures relevant to the user’s circumstance.

### Step 9:

The server notifies the user terminal of the results and shares the information with a public institution. As input, the server uses the identified support measures. The server composes a notification, triggers a push service (such as a mobile push notification or in-app alert), and transmits the info to the user terminal. Simultaneously, the server sends a report to public institution information systems via secure network interfaces. As output, the user receives an actionable message, and the authority receives the analytical report for rapid response.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In emergency or disaster situations, it is difficult to rapidly and accurately collect, analyze, and interpret multimodal information from individuals at risk, and to provide timely and appropriate support services based on the specific situation and emotional state of each individual. Conventional systems often rely on fragmented data collection and lack the capability to perform integrated analysis of audio, image, text, and emotional information, which results in delayed response, inefficient support diagnosis, and insufficient communication with relevant authorities.

The specific processing by the specific processing unit 290 of the data processing device 12 in Application Example 1 is realized by the following means.

The present invention provides a server comprising a processor configured to acquire audio, image, and text information from an information acquisition device, process the collected information using a plurality of analysis algorithms, determine applicable support services based on the processed results, present the determination results to the user, transmit the results to administrative organizations, issue alerts in cases of detected emergency, and estimate the user's emotional state using emotion estimation models. This enables rapid, comprehensive, and accurate assessment of an individual’s situation by integrating multimodal data and emotion recognition, prompt provision of suitable support services, real-time notification to administrative organizations, and efficient emergency response tailored to the individual’s needs.

The term “processor” refers to a computing unit that executes instructions for data acquisition, analysis, decision-making, and communication according to programmed logic.

The term “information acquisition device” refers to hardware configured to collect audio, image, and text data, such as portable electronic terminals, sensors, or input peripherals.

The term “audio information” refers to data representing sound collected from the environment, such as voice recordings, ambient sounds, or other acoustic signals.

The term “image information” refers to visual data captured by optical means, such as photographs, video frames, or real-time video streams.

The term “text information” refers to character-based data, including manually input messages, transcribed speech, or system-generated textual content.

The term “analysis algorithm” refers to a set of programmed instructions or models used to process and interpret multimodal data, including automatic recognition, image analysis, or natural language processing.

The term “support services” refers to aid, assistance, or emergency response options that are determined and recommended according to the diagnosis of a user’s needs.

The term “determination result” refers to the outcome produced by the processor after analyzing input data and identifying appropriate support or actions.

The term “information presentation device” refers to hardware or software components that convey determination results to a user, such as a display, alert system, or user interface.

The term “administrative organization” refers to public or governmental entities that receive shared determination results and may provide support or take further action.

The term “information transmission device” refers to hardware or infrastructure that communicates determination results or alerts to external systems or entities, including administrative organizations.

The term “alert” refers to a warning or notification signal issued when an emergency condition is detected by the system.

The term “emotion estimation model” refers to a computational model configured to evaluate and quantify the emotional state of a user based on audio information, image information, or both.

One embodiment for implementing the invention involves a system in which an information acquisition device, such as a smartphone, tablet, or other portable electronic terminal, is used by the user to collect audio information, image information, and text information. The terminal is equipped with hardware such as a microphone, camera, display, and communication interface. The system is connected to a server that comprises a processor, memory, network interface, and necessary storage.

The user operates the terminal to record voices through the microphone, capture images or video via the camera, and enter text using an input interface (such as a touchscreen keyboard). The terminal attaches metadata such as timestamps and location information, which are obtained from integrated modules such as a clock and GPS receiver. This collected data is transmitted in real-time or at set intervals to the server via secure communication channels such as HTTPS.

The server receives the multimodal data and executes software programs developed in programming languages such as Python. The server utilizes various software tools and machine learning libraries, including, but not limited to, TensorFlow for neural network modeling, OpenCV for image processing, and speech recognition frameworks such as SpeechRecognition or DeepSpeech. For emotion estimation, the server deploys emotion estimation models trained to recognize users’ emotional states based on both speech and facial features. Natural language processing algorithms are employed to interpret the content of the speech and text data.

The processor in the server analyzes and interprets the audio, image, and text information through a combination of automatic recognition algorithms, image recognition algorithms, and emotion estimation models. The analysis results are aggregated, after which the processor determines which support services are applicable based on a pre-registered support service database. The determined support is then transmitted to the user’s terminal, where it is displayed on the application interface along with guidance and options for additional actions.

When an emergency or high-risk situation is detected, the analysis algorithms prompt the processor to issue an alert. The server sends the corresponding alert and relevant information to administrative organizations or emergency response agencies through secure information transmission devices or external APIs. All related data, diagnosis results, and communications are securely stored in a database for further follow-up and tracing.

For example, when a user walking outside perceives a threat, the user activates the emergency reporting application and records a quick voice message while taking a photo of the surroundings. The server analyzes the urgent tone in the user’s voice and suspicious objects or persons in the image, estimates a state of fear or distress, and automatically suggests immediate intervention while notifying authorities.

A sample prompt sentence that may be used for integration with a generative AI model or for user guidance could be as follows:

"If a user feels in danger, how can a smartphone app utilize the device’s camera and microphone to quickly notify the police with all relevant information?"

This system thereby enables rapid, integrated, and emotion-sensitive assessment of a user’s situation, selection of appropriate support services, real-time communication with relevant organizations, and robust emergency response using state-of-the-art hardware and software technologies.

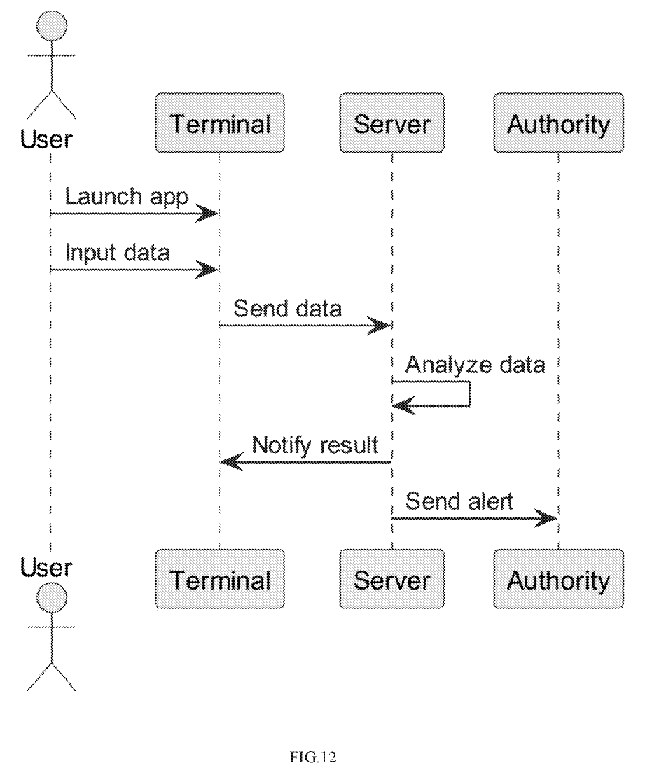

The following describes the processing flow using FIG. 12.

### Step 1:

User launches the emergency application on the terminal.

Input: User action (app launch, command selection).

Terminal activates its microphone, camera, and text input interface, prompting the user to record voice, capture an image or video, and optionally enter text describing the situation.

Output: Raw audio data, image or video data, text data, and automatically generated metadata (timestamp, location).

### Step 2:

Terminal processes and formats the collected data.

Input: Audio, image/video, text, metadata.

Terminal compresses media data if necessary, converts audio to a standard format (such as WAV), and aggregates all data along with metadata into a structured data packet (such as JSON).

Output: Formatted data packet containing media files and metadata.

### Step 3:

Terminal transmits the data packet to the server over a secure network.

Input: Formatted data packet.

Terminal establishes a secure HTTPS connection and uploads the packet to the server endpoint, verifying transfer completion.

Output: Confirmation of data delivery to the server.

### Step 4:

Server receives the data packet and performs pre-processing.

Input: Data packet with audio, image/video, text, and metadata.

Server extracts and temporarily stores each data type, standardizes formats (such as audio sample rate adjustment), and removes noise from audio using digital signal processing algorithms.

Output: Pre-processed audio data, image/video data, text data, and metadata ready for analysis.

### Step 5:

Server analyzes the audio data using speech recognition and emotion estimation models.

Input: Pre-processed audio data.

Server uses a speech-to-text engine (such as TensorFlow or DeepSpeech models) to transcribe the audio, and applies an emotion recognition model to estimate the user's emotional state based on vocal characteristics.

Output: Text transcript of the user's speech and estimated emotion (e.g., distress, fear, calm).

### Step 6:

Server analyzes the image or video data using computer vision algorithms.

Input: Pre-processed image or video data.

Server uses image processing libraries (such as OpenCV and TensorFlow) to detect objects, people, or hazardous situations in the image/video, assigning labels and confidence scores to the findings.

Output: Structured data describing recognized objects, persons, or situations and their likelihood.

### Step 7:

Server combines all analysis results and determines the most appropriate support service.

Input: Audio transcript, emotion estimation, image/video analysis results, metadata.

Server aggregates the data, queries a support service database, and runs decision logic to select or recommend possible support actions based on risk assessment and user status.

Output: Diagnosed support service options and recommended emergency or support actions.

### Step 8:

Server sends results and notifications to the user and relevant authorities.

Input: Diagnosed support and action recommendations.

Server generates response messages: notifies the user’s terminal with available options, provides instructions, and, in high-risk cases, sends incident details and alerts to administrative organizations using secure communication protocols.

Output: User notification (app alert, guidance), and transmission of incident information to authorities.

### Step 9:

Server logs all processed data and tracks status for potential follow-up.

Input: All incoming data and communication records.

Server stores records securely in a database, updates case status, and may initiate scheduled follow-up notifications to ensure the user’s ongoing safety and support.

Output: Archived case record and potential creation of a follow-up schedule.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In traditional disaster victim support systems, it has been difficult to accurately recognize users' emotional states and needs, which often leads to inappropriate or delayed support. Moreover, existing systems lack efficient mechanisms to rapidly analyze multimodal data (such as audio, video, and text), make tailored support program recommendations, and share these determinations promptly with local authorities or related organizations. As a result, disaster victims may experience delays or receive inadequate aid, and coordination between support agencies may be inefficient.

The specific processing by the specific processing unit 290 of the data processing device 12 in Example 2 is realized by the following means.

The present invention provides a server comprising a processor configured to acquire audio, video, or character data from an information processing device, integrate and analyze the data using multimodal processing, execute inquiry to a generative artificial intelligence model with a prompt sentence to recognize the user’s emotional state and extract required support, determine appropriate support programs, notify the user of available support, and share the result with a local government entity or related organization. This enables rapid and accurate recognition of victims' emotional and situational needs, efficient determination of relevant support programs, and prompt information sharing with authorities, thereby improving the effectiveness and timeliness of disaster support.

The term "processor" refers to a central processing unit or computational hardware capable of executing programmed instructions to perform specific data processing functions.

The term "information processing device" refers to an electronic apparatus, such as a mobile terminal or computing device, that can acquire, generate, or transmit data including audio, video, or character data.

The term "audio data" refers to digital information representing sound, including but not limited to spoken words, environmental noises, or other acoustic signals.

The term "video data" refers to digital recordings of visual information, which may include images, sequences of images, or moving pictures, typically collected via an imaging device such as a camera.

The term "character data" refers to information in the form of written symbols, including textual input, alphanumeric codes, or letter-based representations.

The term "multimodal analysis" refers to a data processing approach that integrates and analyzes multiple types of data, such as audio, video, and character data, to derive comprehensive insights.

The term "generative artificial intelligence model" refers to a computational algorithm or trained network, based on machine learning principles, capable of generating output (such as natural language responses) according to provided prompts and learned data relationships.

The term "prompt sentence" refers to a structured input statement or query presented to the generative artificial intelligence model in order to guide or specify the desired output.

The term "user's emotional state" refers to the psychological or affective condition of a user, such as distress, anxiety, or calmness, as inferred or recognized from multimodal data.

The term "support requirements" refers to the specific types of aid or assistance needed by the user, as extracted from the analysis of multimodal data.

The term "support programs" refers to organized assistance schemes or aid mechanisms, such as government or organizational relief initiatives, suitable for addressing the user's needs.

The term "notify" refers to the process of transmitting information or messages to a user, typically regarding available support programs.

The term "local government entity" refers to an administrative body or public organization responsible for providing community-level services or support in a given area.

The term "related organization" refers to any group or agency other than a local government entity that is involved in the provision of disaster support or aid.

The term "communication channel" refers to any means or protocol for transmitting information between entities, including network interfaces, APIs, or secure messaging systems.

The term "mobile terminal" refers to a portable electronic device, such as a smartphone or tablet, that can acquire, process, and transmit data.

The term "computing device" refers to any apparatus capable of executing programmed instructions, including but not limited to personal computers, servers, or embedded systems.

The term "natural language processing" refers to a category of artificial intelligence techniques focused on analyzing, interpreting, or generating human language data.

The term "image recognition" refers to a computational process capable of identifying or analyzing objects, persons, or features within visual data such as images or video.

The term "speech recognition" refers to a computational process for converting spoken language into machine-readable text or information.

One embodiment for implementing the invention will be described below.

The system comprises a server, a terminal, and a user. The server includes a processor configured to manage and orchestrate all operations of the system. The user employs a terminal, which may be a mobile terminal such as a smartphone or a tablet, or a computing device such as a personal computer, to acquire and submit data relevant to a disaster situation.

The terminal utilizes hardware including a built-in camera and a microphone. The user operates the terminal to capture video data reflecting the disaster scene, such as damaged buildings, and records audio data, for instance, by describing required aid or explaining personal circumstances. The terminal may also offer a graphical user interface to allow the user to input character data, such as name, location, or additional comments.

The terminal aggregates these multimodal data - audio, video, and character data - and transfers them securely to the server via a communication channel, such as Wi-Fi, mobile data (4G/5G), or a wired network. Data transmission can be protected by encryption protocols like TLS.

Upon receiving the data, the server processes the information as follows. For audio data, the server uses speech recognition software, such as open-source DeepSpeech or a commercial speech-to-text API, to perform transcription. For video data, the server applies image recognition software like OpenCV and a machine learning-based damage detection algorithm to evaluate the severity and details of physical damage. Character data are parsed immediately.

Once the raw data are preprocessed, the server performs a multimodal analysis, combining textual, audio, and visual features. The server then prepares a prompt sentence suited to the collected data and submits this prompt to a generative artificial intelligence model, such as GPT-4 or a similar large language model, which is deployed within or accessible from the server.

A prompt sentence used in this system may be:

"Based on the following user data, which disaster relief programs are most suitable?

Video analysis: severe home damage

Audio transcription: 'I have nowhere to stay, I need accommodation.'

Emotional state: distressed and anxious"

The server configures this prompt by integrating analysis results. The generative AI model interprets the prompt, recognizes the user's emotional state and support requirements, and determines which support programs are most applicable. For example, the AI may recommend temporary housing assistance, emergency food supply, or counseling services.

Once the recommended support program is determined, the server sends a notification to the terminal, which presents the user with information about available support in a format such as a push notification or in-app message. The user may view, select, or respond directly to the recommendations.

In addition, the server communicates the analysis results and recommended support to a local government entity or related organization via secure application programming interfaces (APIs) or data transfer protocols. This may be accomplished using standard web service protocols such as HTTPS or SFTP to ensure data privacy and integrity during transmission.

In practical use, all hardware and software components mentioned above can be implemented using generic computing and network resources, widely available mobile devices, open-source software libraries for processing, and standard cloud or local server infrastructure for running the generative AI model and processing logic.

This embodiment allows for rapid, accurate, and context-aware support for disaster victims, and facilitates efficient cooperation between users, support organizations, and government authorities.

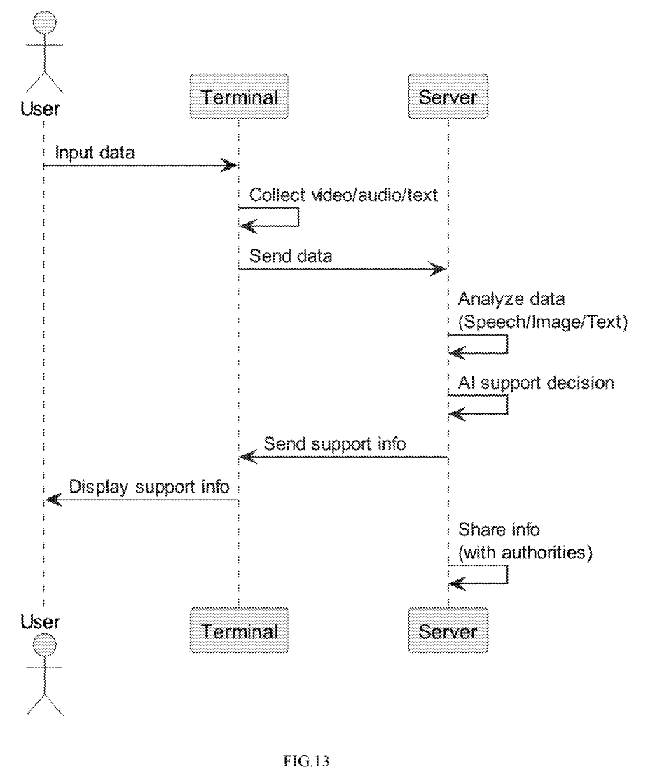

The following describes the processing flow using FIG. 13.

### Step 1:

The user operates the terminal, such as a smartphone or tablet, to record video data showing the disaster site and to capture audio data describing the situation and required assistance. The terminal may also display an input form for the user to enter character data, like name or additional comments.

Input: Real-world disaster scene, user’s voice, and optional text input.

Processing: The terminal utilizes the built-in camera and microphone to collect video and audio data, and a user interface to collect character data.

Output: A structured data package consisting of video file(s), audio file(s), and character data.

### Step 2:

The terminal encrypts the collected data package and establishes a secure communication channel, such as using TLS over Wi-Fi or cellular network, to transmit the data to the server. The terminal sends the data package to a predefined endpoint provided by the server.

Input: Structured data package from Step 1.

Processing: The terminal performs data encryption and initiates file upload over a secure network channel.

Output: Successful transmission confirmation and arrival of the data on the server.

Step 3:

The server receives the data package and verifies its integrity. The server begins data processing by using speech recognition software (such as an open-source speech-to-text API) to transcribe the audio data into text. The server also uses image recognition software (such as OpenCV and a pretrained model) to analyze video content for damage assessment. The server extracts and parses character data, if provided.

Input: Audio file(s), video file(s), and character data received from the terminal.

Processing: The server converts audio to text, analyzes video frames for damage, and parses provided text information.

Output: A combined dataset that includes transcribed text, damage assessment result, and character data.

Step 4:

The server performs multimodal analysis by integrating textual, audio, and visual features from the combined dataset. The server assembles a prompt sentence summarizing the analysis results and submits it to a generative AI model. The model evaluates the prompt to recognize the user’s emotional state and specific support requirements.

Input: Combined and analyzed dataset from Step 3.

Processing: The server merges the analysis results, creates a relevant prompt sentence, and sends it to the generative AI model for inference.

Output: Support recommendation(s) generated by the AI, including recognition of the user's emotional state and suitable support programs.

Step 5:

The server sends the support recommendations to the terminal using a notification mechanism, such as push notification or in-app messaging service. The terminal receives this notification and displays available support options to the user in an understandable format.

Input: Support recommendations and user-specific information from Step 4.

Processing: The server formats the AI outputs and transmits them to the terminal; the terminal then displays the information to the user.

Output: Notification or message shown to the user with details on recommended support programs.

Step 6:

The server compiles a summary of the analysis outcomes and support recommendations. The server establishes a secure API or file transfer session with the local government entity or related organization to transmit the relevant information.

Input: Analysis summary and support recommendations generated in Step 4.

Processing: The server prepares the data in a secure, interoperable format and initiates transfer over secure communication protocol to the designated entity.

Output: Receipt of the data by the local government entity or related organization for further processing or action.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In emergency and disaster situations, it is critical to provide prompt and appropriate support to individuals affected by such incidents. However, conventional support systems face significant challenges in accurately assessing the emotional state and specific needs of each person. Existing systems are limited in their ability to interpret multimodal data, such as audio, image, and textual information, and to generate individualized support plans that adapt to the emotional conditions of users. These shortcomings hinder the effective delivery of mental health care, resource allocation, and safety guidance, and delay the sharing of vital information with relevant organizations.

The specific processing by the specific processing unit 290 of the data processing device 12 in Application Example 2 is realized by the following means.

The present invention provides a server comprising a processor configured to acquire audio information, image information, and character information from an information acquisition device; analyze the acquired information using a multimodal information analysis procedure including acoustic recognition processing, image recognition processing, and natural language processing; diagnose support content based on an identified emotional state; generate an individualized support plan; transmit the support plan or diagnosis to a user terminal in real time; and share the support plan or diagnosis with an external organization through a communication network. This enables the rapid and accurate assessment of an individual’s emotional condition, the generation of optimal support plans tailored to the specific needs of each user, real-time notification to affected individuals, and efficient information sharing with related organizations for coordinated response.

The term “processor” refers to a hardware or software component capable of executing instructions and performing data processing operations necessary for controlling and managing system functions.

The term “audio information” refers to data representing sounds, including spoken language, recordings, or other audible signals, which can be acquired, processed, or analyzed by the system.

The term “image information” refers to data representing visual elements, such as photographs, video frames, or other graphical content, captured through imaging devices and subject to processing or analysis by the system.

The term “character information” refers to data in textual form, which can include written responses, messages, or any other form of digitized letters or symbols provided by a user or generated by the system.

The term “information acquisition device” refers to any hardware terminal, portable computing device, or information processing apparatus that is capable of capturing and transmitting audio, image, or character data to the processor.

The term “multimodal information analysis procedure” refers to a processing workflow that combines two or more distinct modalities, such as acoustic recognition, image recognition, and natural language processing, for comprehensive data analysis.

The term “acoustic recognition processing” refers to the computational technique of analyzing audio data to identify and interpret sounds or spoken language for further processing.

The term “image recognition processing” refers to the computational technique of extracting and interpreting features or patterns from image data to obtain relevant information, such as emotional expressions.

The term “natural language processing” refers to a set of algorithms and models that enable a computer system to understand, interpret, and analyze human language expressed in textual form.

The term “generative artificial intelligence model” refers to a type of machine learning model designed to generate, predict, or infer new data patterns, such as emotional states or recommended actions, based on the analysis of multimodal input data.

The term “emotional state” refers to the cognitive or affective condition of a user, such as stress, anxiety, or well-being, which can be identified through analysis of multimodal data.

The term “support content” refers to the assistance, advice, or remedial measures, including but not limited to support activities, psychological assistance, and safety measures, that are provided to a user based on system diagnosis.

The term “support plan” refers to a structured set of instructions or resources generated by the system, tailoring action steps or recommendations to the individual needs and emotional state of a user.

The term “user terminal” refers to any computing device, such as a smartphone, tablet, or computer, used by an individual to receive notifications or interact with the system.

The term “external organization” refers to any entity outside the system, including but not limited to public agencies, emergency responders, or relief organizations, with which information is shared via a communication network.

The term “communication network” refers to a system or infrastructure that enables data transmission between the server, user terminals, and external organizations, using wired or wireless communication technologies.

### Embodiment for Implementing the Invention

The present invention can be implemented using a system comprising a server with a processor, a user terminal (such as a smartphone, tablet, or personal computer), and an information acquisition device integrated with the user terminal. The processor in the server executes program modules that acquire, analyze, and process audio, image, and textual information in a multimodal manner in order to generate individualized support plans and notifications during emergency or disaster situations.

The terminal functions as the information acquisition device. The terminal uses a built-in microphone to collect audio information (such as the user's voice), a camera to capture image information (such as the user's facial expressions or surroundings), and an input interface (such as a touchscreen or keyboard) to obtain character information (such as typed requests or comments from the user).

The terminal transmits the collected information to the server via a communication network, typically using secure protocols, such as HTTPS. The server receives this multimodal data and performs various preprocessing operations as necessary - for example, segmenting audio streams, resizing images, and formatting textual data.

The server is equipped with software components necessary to analyze the multimodal data. For speech recognition and transcription, the server employs an acoustic analysis processing program, which can be implemented with a third-party application programming interface (API) for speech-to-text conversion (for example, a cloud-based speech recognition service). For image recognition, the server uses an image analysis processing program that can call image analysis APIs to extract emotional features or detect certain objects or scenes (for example, a cloud-based vision analysis service). For natural language understanding, the server runs a natural language processing algorithm, which may include or interact with a generative artificial intelligence model (for example, a deep learning framework such as TensorFlow executing a custom or pretrained model).

The server subsequently interprets the results of these analyses collectively, using data fusion methods, to estimate the user's emotional state and contextual needs. The emotional state may be categorized into levels (such as “high stress”, “moderate anxiety”, etc.) and used to determine appropriate support content. The server then generates a tailored support plan, which may include recommendations for psychological assistance, safety instructions, or the locations of alternative shelters.

The server uses a notification module to send the generated support plan or diagnosis to the user's terminal in real time. The notification can be transmitted using a messaging service or push notification system (for example, a cloud-based messaging service that delivers notifications directly to the terminal’s operating system interface).

Additionally, the server is configured to transmit the diagnosis or support plan to external organizations, such as public agencies or relief institutions, using a secure communication network. The data format and protocol for such sharing can be adapted in accordance with the requirements of the external organizations.

For example, if a user at an evacuation center reports, “I am feeling very anxious," and also displays distressed facial expressions, the terminal records the audio and visual data, and the server processes these inputs to determine a “high stress” emotional state. The server then generates a support plan recommending psychological counseling and provides information regarding a less crowded shelter. The system displays this plan on the user’s terminal and simultaneously shares the information with relevant agencies to facilitate prompt intervention.

An example prompt sentence for a generative AI model is as follows:

“Create a disaster victim support system prompt: Given victims’ speech, video, and text data collected via smartphones, design a process that applies speech-to-text conversion, emotion recognition from videos, and AI-based sentiment analysis to determine stress levels and needs. Use these insights to generate personalized support plans (e.g., alternatives for evacuation, referral to psychological support), notify users in real time, and securely share results with local authorities for rapid assistance.”

This embodiment enables the delivery of rapid, accurate, and context-aware support to individuals in distress, while facilitating efficient information exchange and coordinated response by relevant organizations.

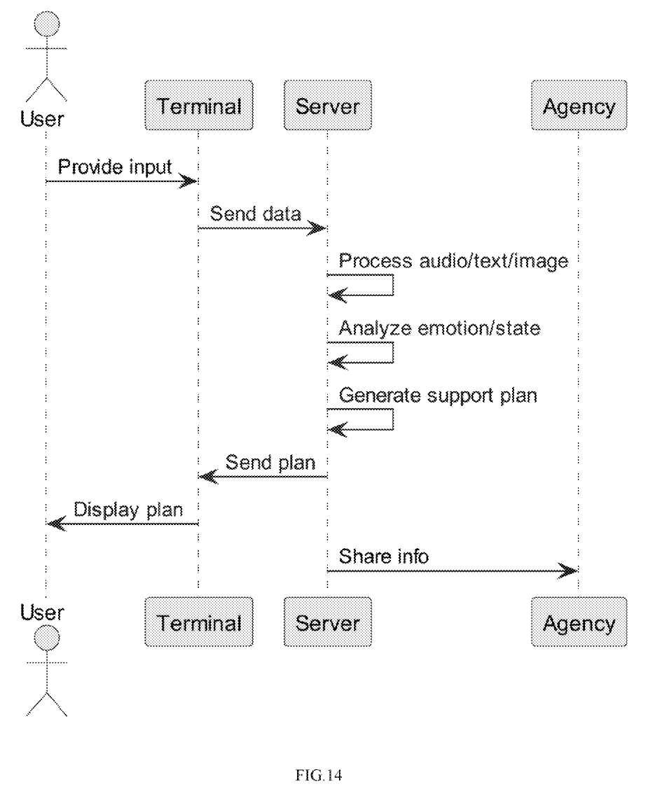

The following describes the processing flow using FIG. 14.

### Step 1:

The user provides input by speaking into the terminal's microphone, looking into the camera, and typing messages via the terminal's input interface.

Input: User’s speech, facial expressions, and textual messages.

The terminal records the audio, captures images or video, and collects the typed text. The terminal prepares this multimodal data for transmission.

Output: Packaged audio data, image or video data, and text data.

### Step 2:

The terminal transmits the packaged data to the server over a secure communication network (e.g., using HTTPS protocol).

Input: Audio data, image or video data, text data from the terminal.

The terminal initiates a secure data transfer to the server, ensuring data integrity and confidentiality during transmission.

Output: Arrival of original multimodal data at the server.

### Step 3:

The server receives the audio data and processes it using an acoustic analysis program to transcribe spoken content into text (e.g., with a cloud-based speech-to-text service).

Input: Audio data from the terminal.

The server performs acoustic signal analysis and speech recognition to convert the user's speech into textual information.

Output: Textual transcription of the user's spoken input.

### Step 4:

The server processes the received image or video data using an image recognition program (e.g., a cloud-based image analysis service).

Input: Image or video data from the terminal.

The server applies facial recognition and emotion detection algorithms to analyze the user's facial expressions or surroundings and to estimate emotional cues (such as anxiety or distress).

Output: Emotion labels or scores associated with the user’s visual data.

### Step 5:

The server integrates the textual transcription, emotion labels from images, and the raw or entered text data using a multimodal data fusion algorithm that includes a generative AI model.

Input: Transcribed text, emotion scores from images, and user-provided text.

The server combines these data types and runs sentiment analysis and inference, identifying the overall emotional state of the user such as "high stress" or "severe anxiety."

Output: Identified emotional state and user need profile.

### Step 6:

The server generates a personalized support plan based on the diagnosed emotional state and user need profile by referencing support content databases and configurable rule sets.

Input: Emotional state, user need profile.

Using the generative AI model and decision logic, the server constructs a set of recommended actions or resources, such as psychological support options or nearby alternative shelters.

Output: Individualized support plan for the user.

### Step 7:

The server transmits the generated support plan to the terminal in real time using a notification system (e.g., a cloud-based messaging service).

Input: Support plan generated by the server.

The server sends the notification, which is displayed on the user’s terminal interface, ensuring immediate delivery and visibility.

Output: Support plan notification shown to the user.

### Step 8:

The server compiles a summary of the diagnosis and support plan and shares the information with external organizations (such as public agencies) through a secure communication channel.

Input: Diagnosis results, individualized support plan.

The server structures and sends the data in a format compatible with external organizational systems, enabling authorities to take prompt action or offer further assistance.

Output: Securely delivered report or alert to an external organization.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

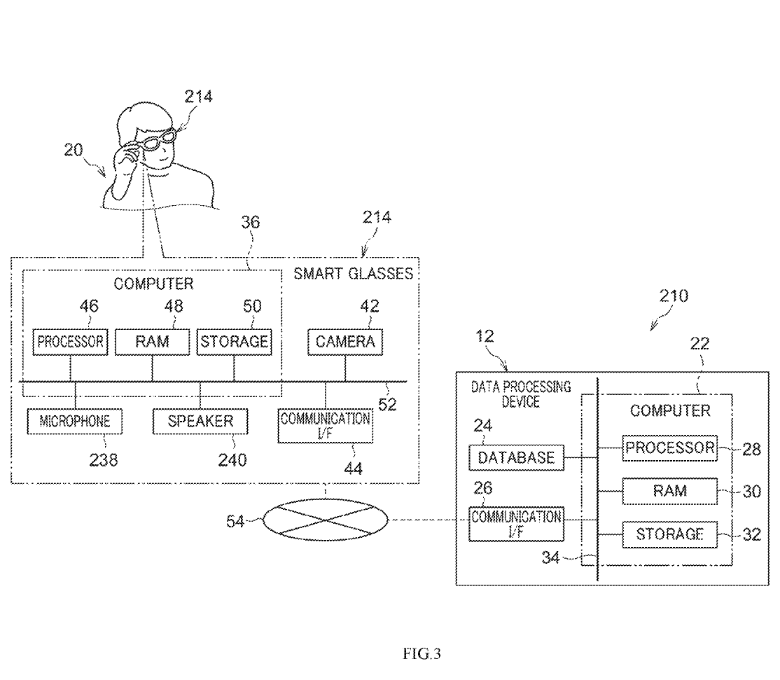

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

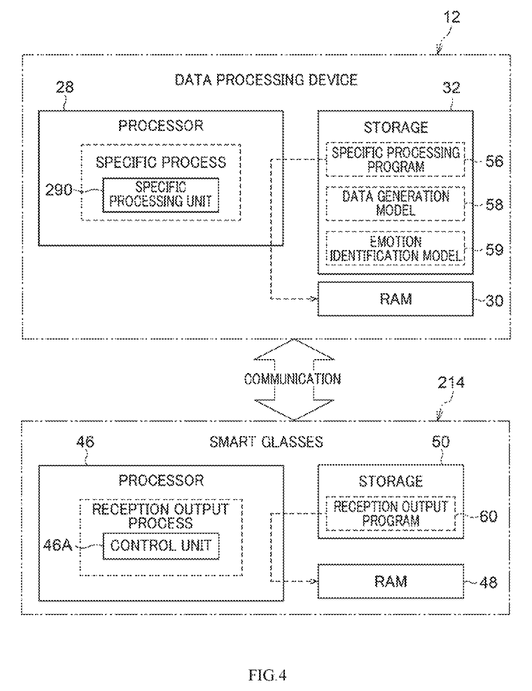

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

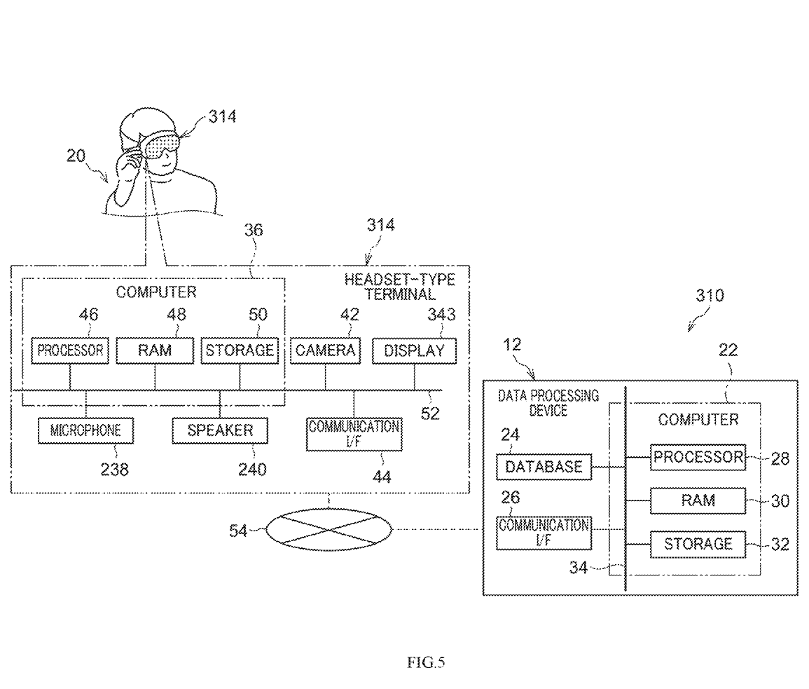

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

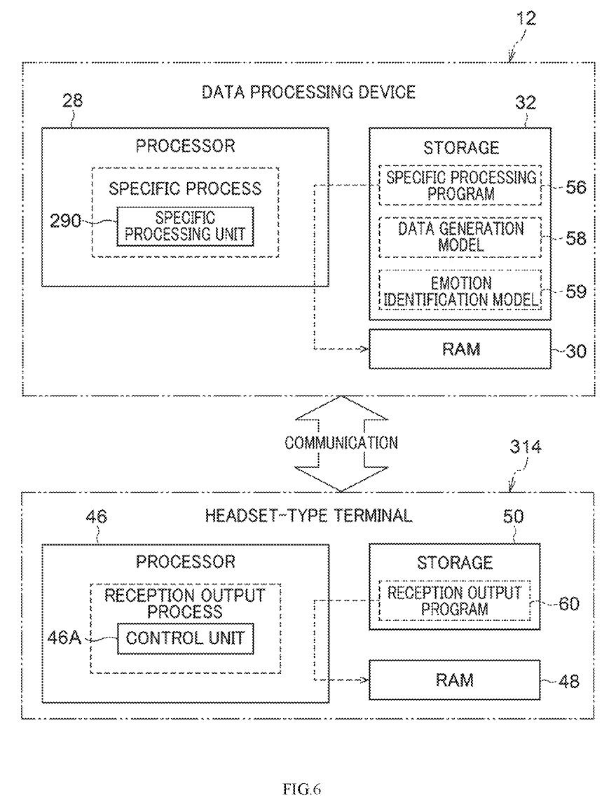

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

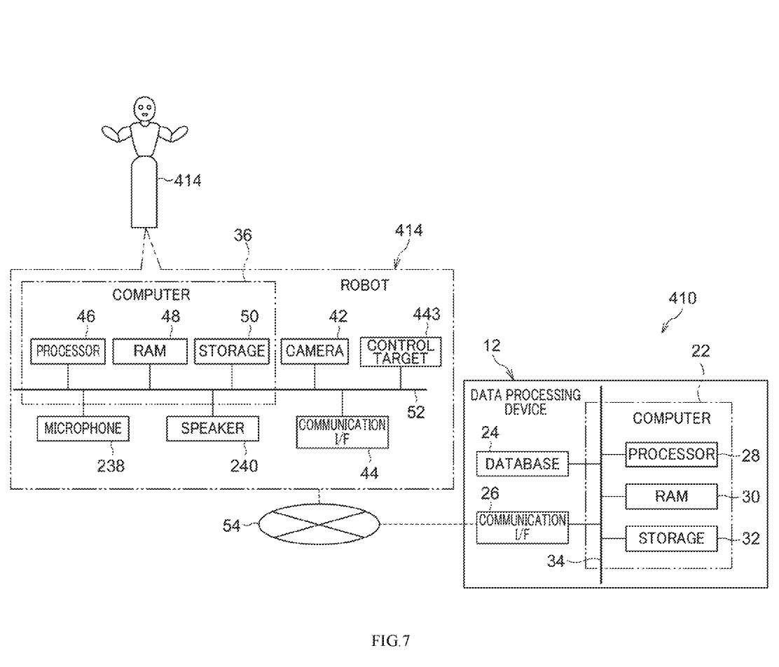

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

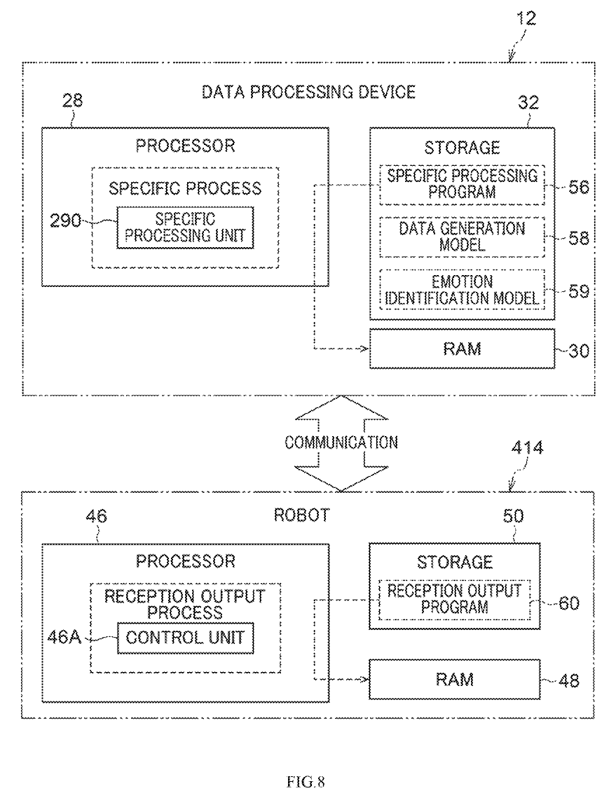

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

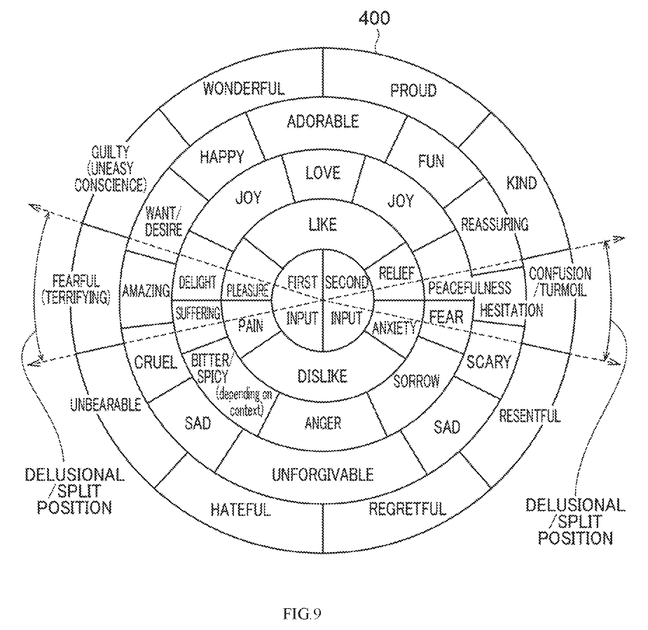

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

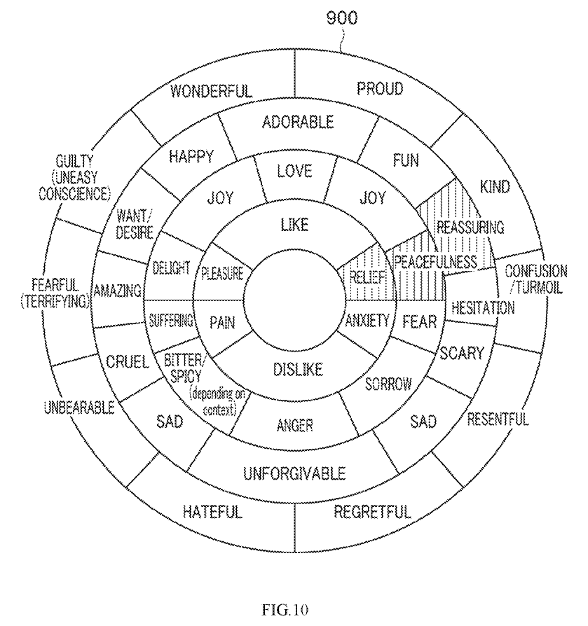

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,

wherein the processor is configured to

obtain spatial information, acoustic information, visual information, and symbolic information via an information collection device,

transmit the obtained multiple types of data together with temporal information and location information through a data transmission means,

integrate the received data and convert it into a multimodal analysis data structure,

generate an analysis instruction sentence in a predetermined format for a generative artificial intelligence model based on the data structure,

input the analysis instruction sentence and the data structure into the generative artificial intelligence model to execute multimodal analysis including transcription of audio information, feature extraction from visual information, or semantic analysis of symbolic information, and to determine the user status or required support,

specify an applicable support measure from a set of support measure information based on the analysis result,

notify the user terminal of the specified result as support information,

and share the result with an external information system belonging to a public institution.

### Supplementary 2

The system according to supplementary 1,

wherein the processor is configured to

control the information collection device so that it is a portable information processing terminal or an information processing apparatus.

### Supplementary 3

The system according to supplementary 1,

wherein the processor is configured to

employ a generative artificial intelligence model including natural language processing technology and image information processing technology in executing the multimodal analysis.

### Application Example 1

### Supplementary 1

A system comprising a processor,

wherein the processor is configured to

acquire audio information, image information, and text information from an information acquisition device,

process the information obtained from the information acquisition device using a plurality of types of analysis algorithms,

determine available support services based on the processed results,

provide the determination result to a user through an information presentation device,

transmit the determination result to an administrative organization through an information transmission device,

issue an alert based on an emergency detected by the analysis algorithms, and

estimate a user's emotion from the audio information or image information using an emotion estimation model.

### Supplementary 2

The system according to supplementary 1,

wherein the processor is configured to

control the information acquisition device that is a portable electronic terminal.

### Supplementary 3

The system according to supplementary 1,

wherein the processor is configured to

apply a plurality of types of automatic recognition algorithms, image recognition algorithms, and emotion estimation models for analysis.

### Example 2

### Supplementary 1

A system comprising a processor,

wherein the processor is configured to

acquire audio data, video data, or character data from an information processing device,

integrate and analyze the acquired data through a multimodal analysis,

execute an inquiry process to a generative artificial intelligence model using a prompt sentence based on the analysis result, the inquiry process including recognition of a user’s emotional state and extraction of support requirements, and determine applicable support programs,

notify the user of the determined support programs, and

share the determination result with a local government entity or a related organization through a communication channel.

### Supplementary 2

The system according to supplementary 1,

wherein the processor is configured to

acquire the data from a mobile terminal or computing device.

### Supplementary 3

The system according to supplementary 1,

wherein the processor is configured to

perform the multimodal analysis or determination of support programs using natural language processing, image recognition, or speech recognition.

### Application Example 2

### Supplementary 1

A system comprising a processor,

wherein the processor is configured to

acquire audio information, image information, and character information from an information acquisition device,

analyze the acquired information using a multimodal information analysis procedure combining acoustic recognition processing, image recognition processing, and natural language processing, in order to identify an individual emotional state,

diagnose appropriate support content selected from support activities, psychological assistance, and safety measures based on the result of the analysis of the emotional state,

automatically generate an individually-structured support plan based on the selected support content,

transmit the generated support plan or the diagnosis result to a user terminal over a communication network in real time,

and share the diagnosis result or the support plan with an external organization through a communication network.

### Supplementary 2

The system according to supplementary 1,

wherein the processor is configured to

utilize, as the information acquisition device, a portable information terminal, a portable computing device, or an information processing device.

### Supplementary 3

The system according to supplementary 1,

wherein the processor is configured to

execute an acoustic analysis processing program for acoustic recognition processing, an image analysis processing program for image recognition processing, and a natural language processing algorithm including a generative artificial intelligence model, as part of the information analysis procedure.

What is claimed is:

1. A system comprising a processor,
wherein the processor is configured to
collect audio data, image data, and text data from a device,
perform multimodal analysis on the data collected from the device,
diagnose applicable support programs based on analysis results obtained by the multimodal analysis,
notify a user of a diagnosis result, and
share the diagnosis result with a local government.

2. The system according to claim 1, wherein the device is a smartphone, a tablet, or a personal computer.

3. The system according to claim 1, wherein the multimodal analysis employs a natural language processing algorithm and an image processing algorithm.
